(19) United States
(12) Patent Application Publication
(10) Pub. No.: US 2012/0055211 A1
(43) Pub. Date: Mar. 8, 2012

(54) GEAR LEVER LOCKING DEVICE

(75) Inventor: Kamol Kantajaraniti, Bangkok (TH)

(73) Assignees: Suwat Petcharapirat, Prachuapkhirikhan (TH); Kamol Kantajaraniti, Bangkok (TH)

(21) Appl. No.: 13/266,347

(22) PCT Filed: Mar. 26, 2010
(86) PCT No.: PCT/TH2010/000013

§ 371 Date: Oct. 26, 2011

(30) Foreign Application Priority Data
Mar. 27, 2009 (TH) 0903000287
May 26, 2009 (TH) 0903000508
May 26, 2009 (TH) 0903000509
May 26, 2009 (TH) 0903000510
Dec. 4, 2009 (TH) 0903001408

(51) Int. Cl. B60R 25/06

(52) U.S. Cl. 70/245

(57) ABSTRACT

A gear lever locking device is provided that can be used to lock a gear lever of an automobile. The gear lever locking device includes a sliding axle and a transverse axle that extends from a main axle pipe and moves between a closed position and an open position. In the closed position, the sliding axle and transverse axle prevent the gear lever from movement.

### FIELD OF THE INVENTION

The present invention relates to a gear lever locking device.

### BACKGROUND OF THE INVENTION

To combat the problem of automobile theft, many different types of automobile anti-theft devices have been developed. Such anti-theft devices include electric anti-theft alarm device units or mechanical devices e.g., a steering wheel locking device or a brake pedal/clutch locking device. However, conventional mechanical anti-theft devices have various drawbacks, such as, the need to install such devices permanently to a steering wheel column thereby causing a potential blockage or hindrance to a user of the automobile controls when driving. Such issues can potentially contribute to unexpected accidents. Additionally, permanently attaching such mechanical devices to a steering wheel column gives an inferior appearance, as such devices are visible from outside the automobile.

Removable mechanical anti-theft devices are also problematic. For when such devices are unused, they must be keep in an area of the automobile that does not obstruct a driver's movement. As a result, such removable anti-theft devices are inconvenient to use.

Another conventional mechanical anti-theft device is a gear lever locking device having a loop retaining an automobile gear lever installed in a position preventing movement of the gear lever. However, such a loop retaining gear lever lock is problematic in that it is not aesthetically pleasing and can potentially be destroyed or disabled by an individual as the device is located or mounted on an existing gear lever outside the cover of the gear lever.

Thus, there is still a need for an automobile gear lever locking device capable of locking a gear lever that addresses the aforementioned problems of conventional mechanical anti-theft devices. Such a need is satisfied by the automobile gear lever locking device of the present invention.

### BRIEF SUMMARY OF THE INVENTION

In accordance with a preferred embodiment, the present invention provides a gear lever locking device having a first main axle pipe, a first sliding axle pipe, a spring, a sliding-pulling axle, an extending axle, an electric switch, and a second main axle pipe. The first main axle pipe includes an interior, a bottom, a side wall, and a bent first fixing leg member. The bent first fixing leg member extends from the bottom of the first main axle pipe for installation in a vehicle at an existing position of a screw of the vehicle. The bent first fixing leg member also includes a through-slot along a rear end of the side wall, an opening along the side wall, and a through hole along the side wall. The first sliding axle pipe has a shape corresponding to the interior of the first main axle pipe and is installed inside the first main axle pipe. The first sliding axle pipe also has a through hole along a side wall of the first sliding axle pipe. The spring is assembled inside a front end of the first sliding axle pipe. The sliding-pulling axle is fixed to the first sliding axle pipe and the through-slot is configured to receive the sliding pulling axle. The extending axle extends through the opening and is fixed to the first sliding axle pipe in a position blocking an area above the screw when the first sliding axle pipe slides into a locked position. The electric switch is mounted to the first main axle pipe and is connected to electric wiring and a security signal circuit operatively connected to the first sliding axle pipe. The second main axle pipe is connected to a front end of the first main axle pipe by a first connecting member and to a front end of the first sliding axle pipe by a second connecting member. The second main axle includes a sliding axle having an end projecting through a side opening on a wall of the second main axle and is bent to form a front transverse rod to block the movement of a gear lever. The second main axle also includes a transverse axle positioned rearwardly from the sliding axle and is bent to form a rear transverse rod. The transverse axle has an inner end pivotably fixed to the second main axle pipe by a stud to block the movement of the gear lever. The transverse axle is configured to turn with a stud fixed to the sliding axle. At least one bent second fixing leg member is connected about a bottom of the second main axle pipe for securing to another existing position of the screw.

In accordance with another preferred embodiment, the present invention provides a gear lever locking assembly having an axle pipe, a rear transverse rod, and a sliding axle. The axle pipe includes a end plate, a first side opening, and a second side opening. The rear transverse rod is connected to the axle pipe and includes a bent rear end projecting through the first side opening for blocking the movement of a gear lever, a front end pivotably connected to the axle pipe by a stud, and an elongated through hole about the front end. The sliding axle includes a bent front end projecting through the second side opening to form a front transverse rod for blocking movement of the gear lever. The sliding axle also includes a rear end connected to a driving mechanism for sliding the sliding axle forwardly and away from the rear transverse rod, and a stud fixed on the sliding axle that extends through the elongated through hole. The rear transverse rod is configured to pivot about the stud when the sliding axle is moved.

In accordance with yet another preferred embodiment, the present invention provides a gear lever locking device having a first axle pipe, a gear lever transverse assembly, a second axle pipe, a second sliding axle and a turning mechanism. The first axle pipe includes a side opening on a wall of the first axle pipe. The gear lever transverse assembly is installed inside the first axle pipe and extends from the side opening. The gear lever transverse assembly includes a first sliding axle having a bent front end projecting through the side opening to form a front transverse rod for blocking movement of a gear lever. The gear lever transverse assembly also includes a bent rear transverse rod projecting through the side opening to form a rear transverse rod for blocking movement of the gear lever and is pivotably connected to the first axle pipe by a stud. The rear transverse rod has an elongated opening about an end and a stud fixed on the first sliding axle extending through the elongated opening. The rear transverse rod is configured to pivot about the stud when the first sliding axle is moved to move the rear transverse rod between an open position and a closed position. The second axle pipe is connected to the first axle pipe. The second sliding axle is installed inside the second axle pipe and operatively assembled to a rear end of the first sliding axle. The turning mechanism is installed on a wall of the second axle pipe and an end of the second sliding axle is operatively assembled with the turning mechanism.

In accordance with another preferred embodiment, the present invention provides a gear lever locking device having a sliding axle chamber, a driving mechanism, and a gear lever transverse mechanism. The sliding axle chamber includes a sliding axle unit slideable therein. The driving mechanism unit is engaged with a first end of the sliding axle unit and has a turning mechanism turnable with a key for driving the sliding axle unit. The gear lever transverse mechanism is provided in a mechanism unit chamber connected to and extending from a second end of the sliding axle unit. The gear lever transverse mechanism includes a plate member extending from a member end of the sliding axle unit. The plate member has a transverse stud in a sliding groove of a gear lever transverse member that moves in relation to a movement of the driving mechanism unit. The gear lever transverse mechanism also includes a fixture connected to the sliding axle chamber for fixing the gear lever locking device to an existing screw position in a vehicle. The gear lever transverse member is configured as a parallel projecting axle positioned transverse to a movement direction of a gear lever and extending from the gear lever transverse mechanism when in a locked position. The gear lever transverse member is retracted from the extended position when in an unlocked position.

In accordance with a further preferred embodiment, the present invention provides a turning mechanism for a sliding axle pipe mechanism of a gear lever locking device having a case, a key lock cylinder, a fixing device, a cam, and a plate. The key lock cylinder is partially housed within the case and turnable with a key. The fixing device connects the turning mechanism to a sliding axle pipe mechanism. The cam is connected to the key lock cylinder by a connecting device and includes a convex stud and a stud. The cam engages with the sliding axle pipe mechanism to drive the sliding axle pipe mechanism and move it in the turning direction of the key lock cylinder. The plate is operatively connected to the cam. The plate includes a stud extending therefrom and a slot for receiving the convex stud. The sliding axle pipe mechanism includes a hole for receiving the stud. The plate is configured to be moved by camming engagement with the cam to withdrawal the convex stud from the slot and the stud from the hole to unlock the sliding axle. The plate is also configured to be moved by the cam to insert the convex stud into the slot to allow a spring to push the stud into the hole and into a lock position.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is an exploded perspective view of a gear lever locking device in accordance with a first preferred embodiment of the present invention;

FIG. 2 is a front perspective view of the gear lever locking device of FIG. 1;

FIG. 3 is another front perspective view of the gear lever locking device of FIG. 1 in a closed configuration;

FIG. 4 is a bottom, front, perspective view of the gear lever locking device of FIG. 1 in an open configuration;

FIG. 5 is a bottom, plan view of the gear lever locking device of FIG. 1;

FIG. 6 is a partial cross-sectional, bottom, plan view of the gear lever locking device of FIG. 1 in the closed configuration;

FIG. 7 is a partial, cross-sectional, elevational view of the gear lever locking device of FIG. 1;

FIG. 8 a partial, cross-sectional, bottom, plan view of the gear lever locking device of FIG. 1 in the open configuration;

FIG. 9 is a partial, cross-sectional, bottom, plan view of the gear lever locking device of FIG. 1 in the open configuration;

FIG. 10 is an exploded perspective view of a turning mechanism of the gear lever locking device of FIG. 1;

FIG. 11 is a schematic circuit diagram of electric wirings for the gear lever locking device of FIG. 1;

FIG. 12 is an exploded perspective view of a gear lever locking device in accordance with a second preferred embodiment of the present invention;

FIG. 13 is an exploded perspective view of a gear lever locking device in accordance with a third preferred embodiment of the present invention;

FIG. 14 is a partial, cross-sectional, top plan view of the gear lever locking device of FIG. 13;

FIG. 15 is an exploded perspective view of a turning mechanism of a gear lever locking device in accordance with a fourth preferred embodiment of the present invention;

FIG. 16 is a greatly enlarged, partial cross-sectional, top plan view of the turning mechanism of FIG. 15;

FIG. 17 is a partial, cross-sectional, perspective view of the gear lever locking device of FIG. 15;

FIG. 18 is an exploded perspective view of a gear lever locking device in accordance with a fifth preferred embodiment of the present;

FIG. 19 is a perspective view of the gear lever locking device of FIG. 18 in a closed configuration; and

FIG. 20 is a perspective view of the gear lever locking device of FIG. 18 in an open configuration.

### DETAILED DESCRIPTION OF THE INVENTION

Reference will now be made in detail to the present preferred embodiments of the invention illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. Such directional terms used in conjunction with the following description of the drawings should not be construed to limit the scope of the invention in any manner not explicitly set forth.

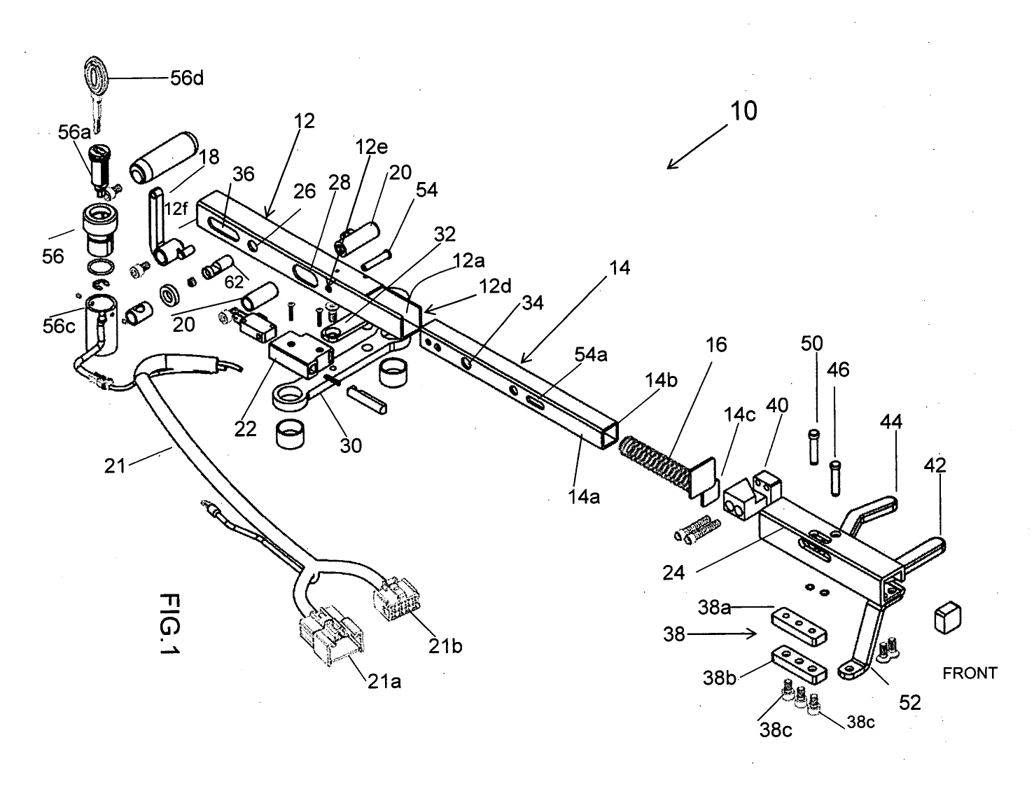

In accordance with a first preferred embodiment, the present invention provides for a gear lever locking device 10, as shown in FIGS. 1-11. The gear lever locking device 10 includes a first main axle pipe 12, a first sliding axle pipe 14, a spring 16, a sliding pulling axle 18, an extending axle 20, an electric switch 22, and a second main axle pipe 24. As best shown in FIGS. 1-4, the first main axle pipe 12 is generally configured as an elongated first main axle pipe 12 and includes an interior 12a, a bottom 12b, and a side wall 12c. The first main axle pipe 12 also includes a through slot 26 about a rear end of the side wall 12c, and an opening 28 along the side wall 12c.

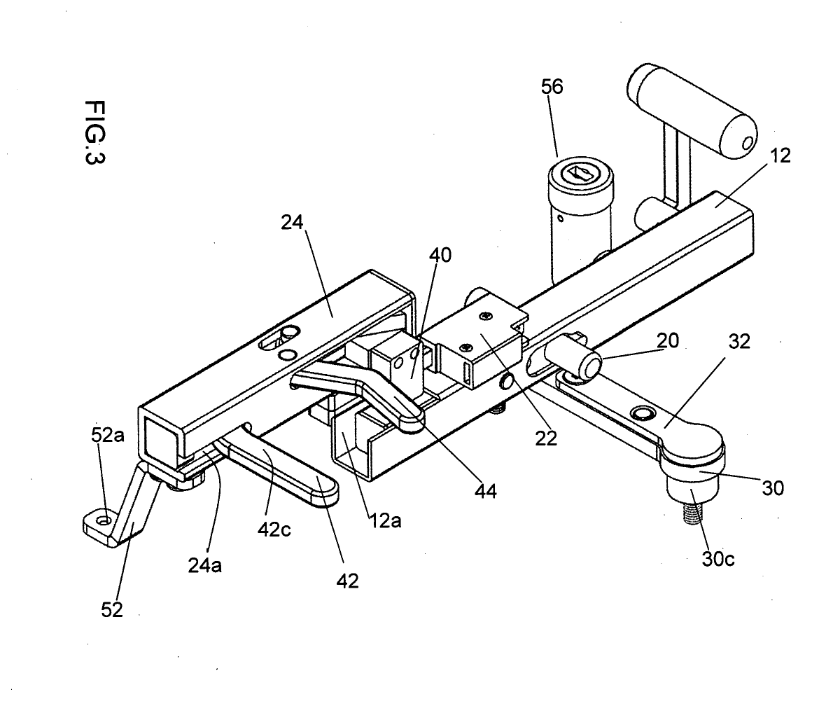

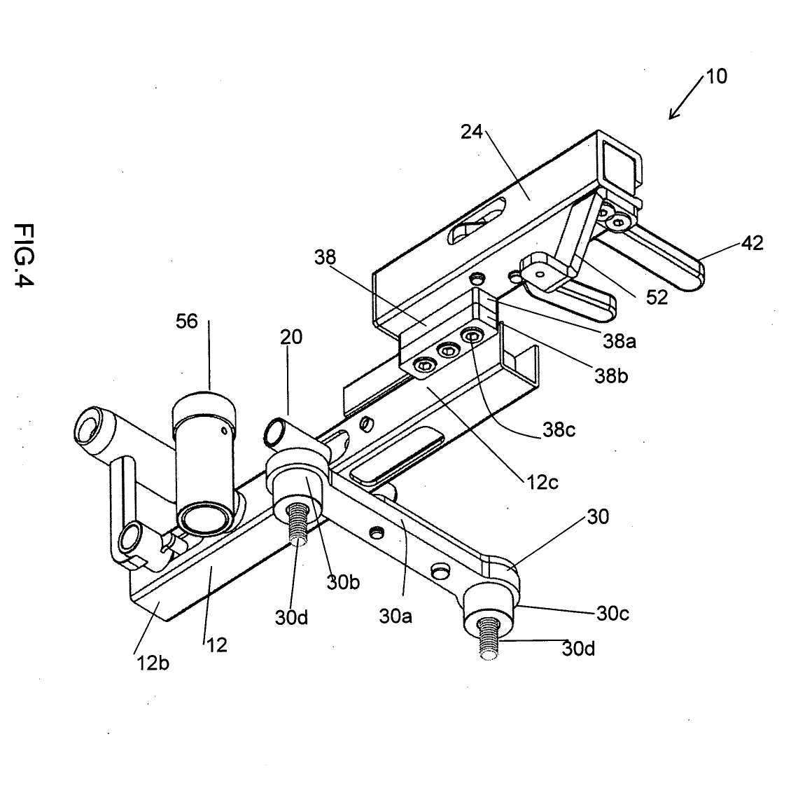

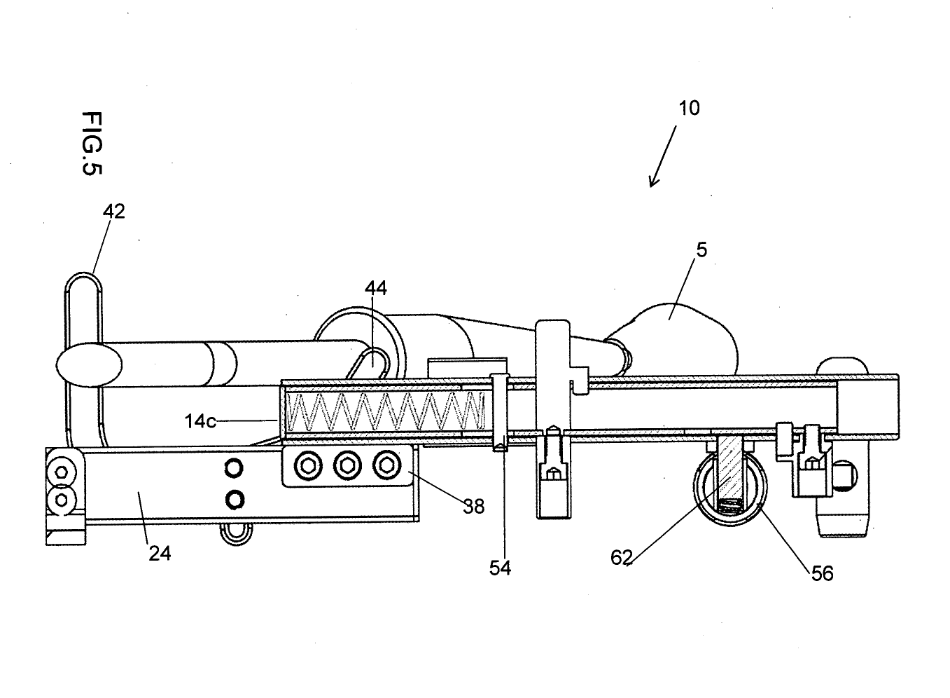

A bent first fixing leg member 30 is connected to the bottom 12b of the first main axle pipe 12. The bent first fixing leg member 30 is configured as best shown in FIGS. 3 and 4, and includes an elongated member 30a having first and second ends 30b, 30c. The first and second ends 30b, 30c are each configured as a tubular member for receiving a screw 30d that secures the first fixing leg member 30 to an existing screw position on a vehicle (not shown). That is, the first and second ends 30b, 30c are configured to mount, preferably on e.g., a center console of the vehicle near a gear lever 5 (FIG. 5). The first fixing leg member 30 also includes a screw guard 32 that covers an upper end of the first fixing leg member 30 so as to cap the first and second ends 30b, 30c.

The first sliding axle pipe 14 is generally configured as an elongated axle pipe, as shown in FIG. 1. The shape of the first sliding axle pipe 14 corresponds to the shape of the first main axle pipe's interior 12a. Thus, the first sliding axle pipe 14 is installable within the first main axle pipe 12. The first sliding axle pipe 14 also includes a through hole 34 along a side wall 14a of the first sliding axle pipe 14.

The spring 16 can be any spring or biasing member generally known in the art, such as, a compression spring or a constant force spring. The spring 16 is sized and configured to be received within a front end 14b (FIG. 1) of the first sliding axle pipe 14.

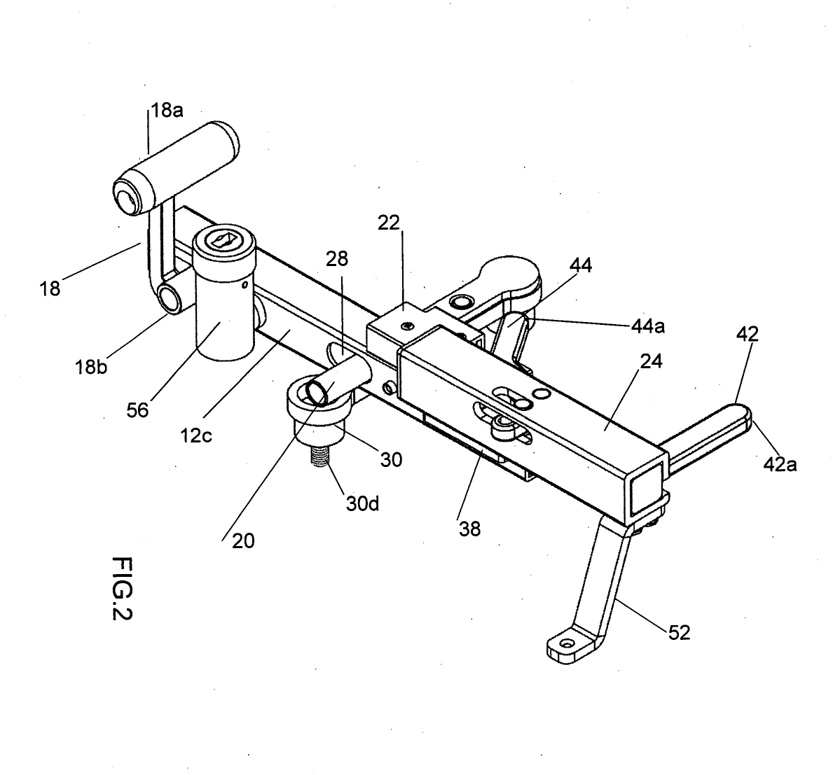

The sliding-pulling axle 18 is generally configured, as best shown in FIGS. 1 and 2. The sliding-pulling axle 18 includes a handle 18a connected to a stud 18b that is received within the first main axle pipe 12. That is, the through slot 36 of the first main axle pipe 12 is configured to receive the stud 18b of the sliding-pulling axle 18 such that the sliding-pulling axle 18 can slide along the longitudinal length of the elongated through slot 36.

The extending axle 20 is generally configured as a stud, as best shown in FIGS. 1 and 2. The extending axle 20 is connected to the first main axle pipe 12 so as to extend through the opening 28 of first main axle pipe 12. The extending axle 20 is also configured to extend to a position such that the extending axle 20 blocks an area above the screw 30d of the first fixing leg 30 when the first sliding axle pipe 14 slides into a lock position or closed configuration.

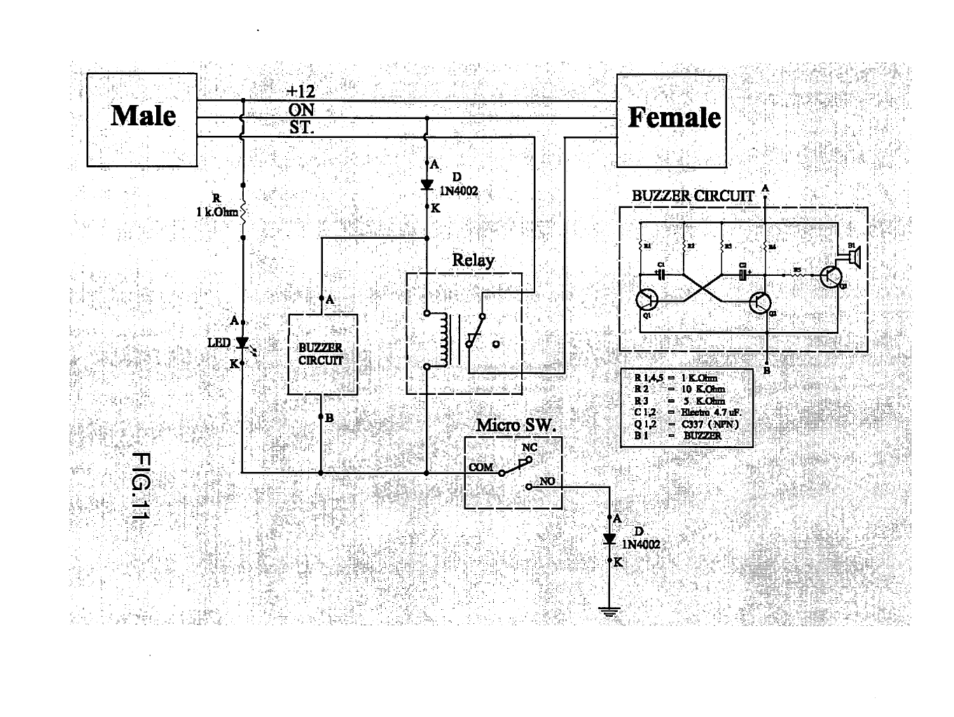

The electric switch 22 is mounted to the first main axle pipe 12 (FIGS. 1 and 2) and connected to electric wiring. The electric switch 22 is also connected to a securing signal circuit 21 having a first socket 21a and second socket 21b. The first socket 21a is connectable to wirings. The second socket 21b is connectable to electric wires having a buzzer circuit (FIG. 11) within the securing signal circuit 21. FIG. 11 illustrates a schematic circuit diagram for connecting the gear lever locking device 10 to an electric anti-theft system (not shown). A ground for the securing signal circuit 21 is connected to the switch 22.

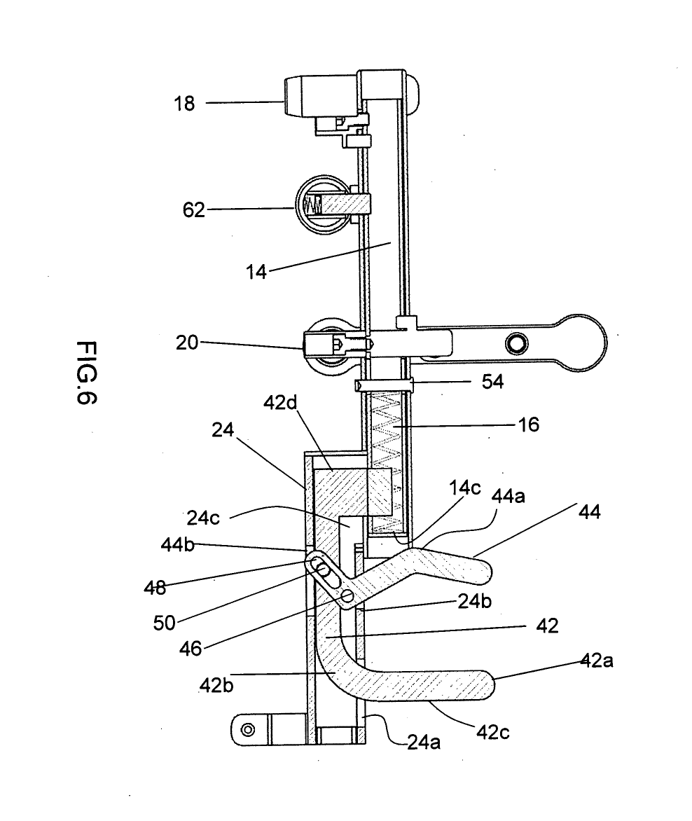

The second main axle pipe 24 is generally configured as an elongated axle pipe, as best shown in FIGS. 1-4. The second main axle pipe 24 is connected to a front end 12d of the first main axle pipe 12 by a first connecting member 38 (FIG. 4) and to a front end 14b of the first sliding axle pipe 14 by a second connecting member 40 (FIG. 3). The second main axle pipe 24 also includes a sliding axle 42 and a transverse axle 44 that form locking arms movable between a closed configuration (FIG. 3) and an open configuration (FIG. 2). The sliding axle 42 has an end 42a that projects through an opening 24a of the side wall of the second main axle pipe 24 (FIG. 3). The sliding axle 42 is configured to have a bend 42b (FIG. 6) to form a front transfer member 42c that blocks movement of the gear lever 5.

As best shown in FIG. 6, the second main axle 24 also includes the transverse axle 44 positioned rearwardly from the sliding axle 42. The transverse axle 44 is bent to form a rear transverse rod 44a having an inner end 44b pivotably fixed to the second main axle pipe 24 by a stud 46 for blocking movement of the gear lever 5. The transverse axle 44 also includes an elongated opening 48 about is inner end 44b that receives a stud 50 connected to the sliding axle 42. Thus, as the sliding axle 42 slides along the length of and inside the second main axle pipe 24, the stud 50 causes the transverse rod 44 to turn about the stud 46. Accordingly, sliding of the sliding axle 42 moves the sliding axle 42 and transverse axle 44 between the open and closed configurations.

The second main axle 24 includes at least one bent second fixing leg member 52 (FIG. 3) about a bottom of the second main axle pipe 24 for securing the gear lever locking device 10 in an existing position of another screw of the vehicle. That is, the second fixing leg member 52 has a through hole 52a for receiving an existing screw (not shown) located about the console of the gear lever 5 of the vehicle and connecting thereto.

The gear lever locking device 10 can include one and preferably two extending axles 20. The extending axles 20 can each be fixed or connected to a side wall of the first sliding axle pipe 14 such that each extending axle 20 extends through the respective openings i.e., 28, along the sidewalls of the first main axle pipe 12 (FIG. 4).

In an assembled configuration, the retractable spring 16 is inserted within the front end 14b of the first sliding axle pipe 14 and pushes against an end cap 14c that is securely fixed to and closes off the front end 14b. An opposite end of the retractable spring 16 pushes against a transverse stud 54, as best shown in FIG. 5. The transverse stud 54 is fixed transversely to the side walls 12c of the first main axle pipe 12. Specifically the transverse stud 54 passes through opening 12e of the first main axle pipe 12 and an opening 54a along the first sliding axle pipe 14. The length of the opening 54a of the first sliding axle pipe 14 has a longitudinal length equal to a predetermined sliding length of the first sliding axle pipe 14 relative to the first main axle pipe 12.

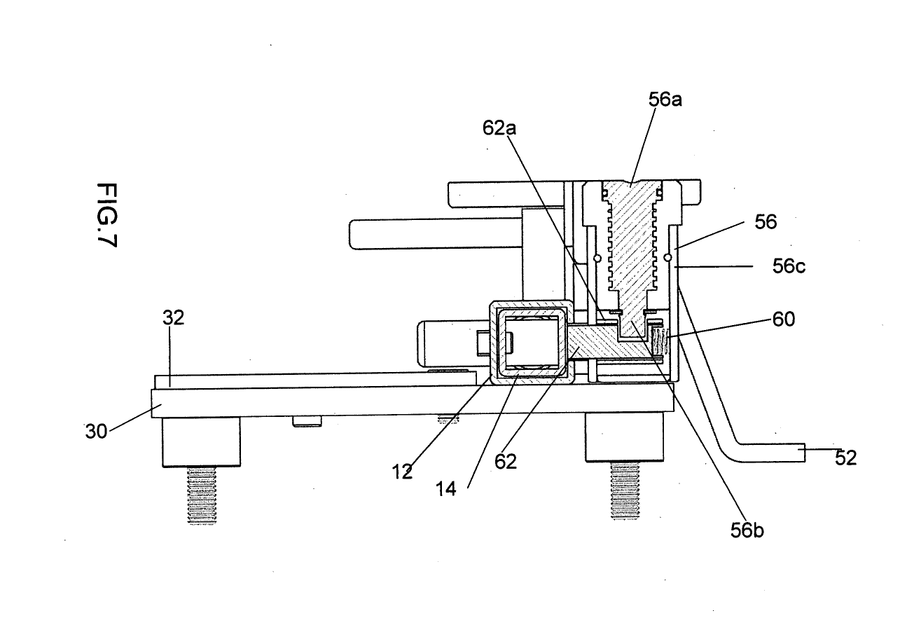

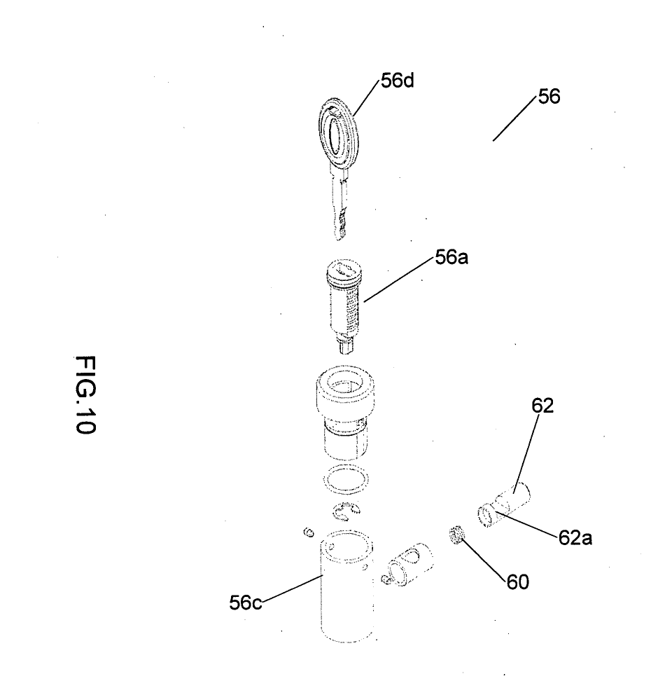

The gear lever locking device 10 further includes a turning mechanism 56 to lock and unlock the gear lever locking device 10 from the locked configuration, as best shown in FIGS. 1, 2, 6, 7 and 10. Referring to FIG. 7, the turning mechanism 56 is preferably installed on the side wall 12c of the first main axle pipe 12. The turning mechanism 56 includes a turning lock 56a, a spring 60, and a locking stud 62. The turning lock 56a is configured with an offset part 56b that is insertable within a rear groove 62a of the locking stud 62. The locking stud 62 is configured to extend from within a casing 56c of the turning mechanism 56, in a transverse orientation relative to a central axis of the turning lock 56a, through through-holes 26 and 34 of the first main axle pipe 12 and the first sliding axle pipe 14, respectively. FIG. 7 illustrates the turning mechanism 56 in a locking position. That is, the locking stud 62 extends into the sliding axle pipe 14 to prevent the sliding axle pipe 14 from sliding relative to the first main axle pipe 12. To move the turning mechanism 56 to an unlocking position, the user turns the turning lock 56a via a turning key 56d (FIG. 10) such that the offset part 56b urges against a portion of the groove 62a to withdraw the locking stud 62 from the first sliding axle pipe 14 and into the casing 56c, thereby compressing the spring 60. In the unlocking position, the sliding axle pipe 14 is free to slide within the first main axle pipe 12 either by the force of the retractable spring 16 or by a user sliding the sliding-pulling axle 18.

The spring 60 is located within the casing 56c and positioned between the locking stud 62 and an internal wall surface of the turning mechanism's casing 56c, such that the spring 60 can bias the locking stud 62 to a locking position in which the locking stud 62 extends through through-holes 26 and 34. The turning mechanism 56 is configured such that upon the turning lock 56a being turned, the offset part 56b pushes or cams against the locking stud 62 to move it from the locking position to the unlocking position, thereby allowing the first sliding axle pipe 14 to slide relative to the first main axle pipe 12. The force for sliding the first sliding axle pipe 14 being provided by the force of the compressed retractable spring 16.

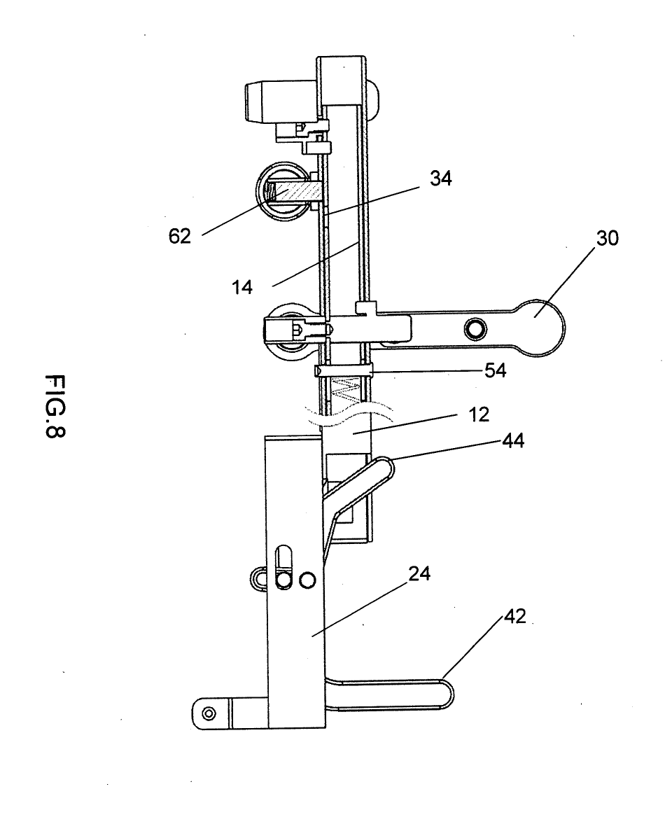

The first sliding axle pipe 14 is movable between a first position and a second position. The second position corresponds to a location of the extending axle 20 being located exactly above the screw 30d of the first fixing member 30 (FIG. 6). FIGS. 2 and 8 illustrate the positioning of the extending axle 20 as the first sliding axle pipe 14 slides within the first main axle pipe 12. The extending axle 20 extends through and is configured to slide along the length of the elongated opening 28 of the first main axle pipe 12 between the first position and the second position.

FIG. 2 illustrates the gear lever locking device 10 in an assembled state and wherein the transverse axle 44 and the sliding axle 42 are in the open configuration. In the assembled state the sliding axle pipe 14 is installed inside the first main axle pipe 12 and the spring 16 installed within the front end 14b of the first sliding axle pipe 14.

The sliding-pulling axle 18 is connected to the gear lever locking device 10 about a rear end 12f of the first main axle pipe 12, such that the sliding-pulling axle 18 is slidable within the through slot 36. The turning mechanism 56 is assembled slightly forward of the sliding-pulling axle 18 such that the locking stud 62 extends through through-holes 26 and 34, respectively. The second main axle pipe 24 is connected to the first main axle pipe 12 and the sliding axle pipe 14 via first and second connecting members 38, 40, respectively (FIGS. 3 and 4). The transverse axle 44 and the sliding axle 42 each have respective ends 44a, 42a that extend out through side openings 24b, 24a of the second main axle 24, transverse to the longitudinal direction of the second main axle 24, as best shown in FIGS. 3 and 6.

FIG. 4 best shows the first fixing leg member 30 and second fixing leg member 52. Each of the first and second fixing leg members 30, 52 allow the gear lever locking device 10 to be connected to the vehicle via screws. Preferably, the first fixing leg member 30 and the second fixing leg member 52 are positioned at corresponding positions to an existing screw on the vehicle, and more preferably, to existing screws about the console of the vehicle near the gear lever 5.

FIG. 6 illustrates the assembly of the transverse rod 44 and the sliding axle 42 to the second main axle 24, as shown in a partial cross-sectional view. The sliding axle 42 includes a front end 42a and a rear end 42d. In general, the sliding axle 42 has an “L” shaped configuration. The sliding axle 42 is housed within the second main axle pipe 24 with the rear end 42d extending through an opening 24c of the second main axle pipe 24 and a front end 42a extending through the opening 24a of the second main axle pipe 24. The rear end 42d is also connected to the sliding axle pipe 14 such that the sliding axle 42 slides in the longitudinal direction within the second main axle pipe 24 as the sliding axle pipe 14 slides within the first main axle pipe 12.

The transverse rod 44 is generally configured as shown in FIG. 6 having a generally “Z” shaped configuration. The transverse rod 44 has its first end 44a extending through opening 24b of the second main axle pipe 24 and a second end or inner end 44b that resides within or substantially within the second main axle pipe 24. The transverse rod 44 is also pivotably connected to and within the second main axle pipe 24 via stud 46. About the second end 44b of the transverse rod 44 is the elongated opening 48. The elongated opening 48 receives the stud 50 that extends from a mid portion of the sliding axle 42, such that as the sliding axle 42 is moved or driven to slide along the second main axle pipe 24, due to movement of the stud 50 the transverse rod 44 is pivoted in either the forward or rearward direction. In particular, as the sliding axle 42 is moved in the rearward direction, the transverse rod 44 is configured to move in the forward direction such that the transverse rod 44 and the sliding axle 42 move from the closed configuration to the open configuration.

The operation of the gear lever locking device 10 with respect to the first sliding axle pipe 14 is best shown in FIGS. 5 and 6. Referring FIG. 6, the first main axle pipe 12 has the transverse stud 54 connected about its mid portion. The transverse rod 54 is also configured to reside within the elongated opening 54a of the sliding axle pipe 14 when assembled within the first main axle pipe 12. The spring 16 is positioned within a front end of the sliding axle pipe 14 between the end plate 14c and the transverse stud 54. The sliding axle pipe 14 is maintained within the closed configuration by the turning mechanism 56 and sliding pulling axle 18. That is, the turning mechanism 56 provides a locking means to lock the gear lever locking device 10 from sliding and moving from the closed configuration to the open configuration.

In operation, the gear lever locking device 10 is used to securely locked the gear lever 5 or gear stick of a vehicle in position until the gear lever locking device 10 is unlocked or moved from the closed configuration to the open configuration. To move the gear lever locking device 10 to the open configuration, a user must first unlock the turning mechanism 56 such that the locking stud 62 is moved from the locking position to the unlocking position. This can be accomplished, for example, by a key 56d that is inserted into the turning unit 56a, as shown in FIG. 1. Upon the turning mechanism 56 being unlocked, the user can then slide the sliding-pulling axle 18 forwardly to move the sliding axle 42 forwardly, such that the transverse rod 44 and the sliding axle 42 move to the open configuration, thereby allowing the user to freely move the gear lever 5.

FIG. 4 shows the second main axle 24 connected to the first main axle pipe 12 by a connecting member 38. The connecting member 38 includes a top manifold 38a and a bottom manifold 38b connectable by fasteners, such as screws 38c. The top manifold 38a is connected to the second main axle 24 and the bottom manifold 38b is connected to the first main axle pipe 12 such that the top and bottom manifolds 38a, 38b can be connected by screws 38c.

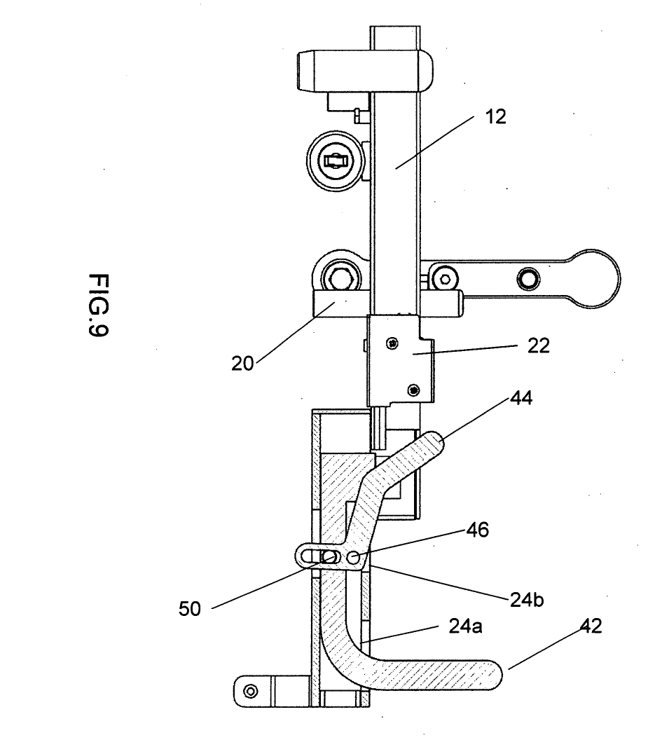

FIGS. 8 and 9 illustrate the gear lever locking device 10 in the open configuration with each of the transverse axle 44 and the sliding axle 42 in a spread out/open configuration. In the open configuration, the gear lever 5 (FIG. 5) is freely movable between the transverse axle 44 and the sliding axle 42. Plus, as shown in FIG. 9, the extending axle 20 is no longer positioned directly over the screw 30d that secures the first fixing leg member 30 to the vehicle.

FIG. 8 shows the gear lever locking device 10 with the turning member 56 in the unlocking position i.e., with the locking stud 62 withdrawn from the first sliding axle pipe 14. The gear lever locking device 10 is also shown in the open configuration such that the through hole 34 of the sliding axle pipe 14 is offset from the position of the locking stud 62.

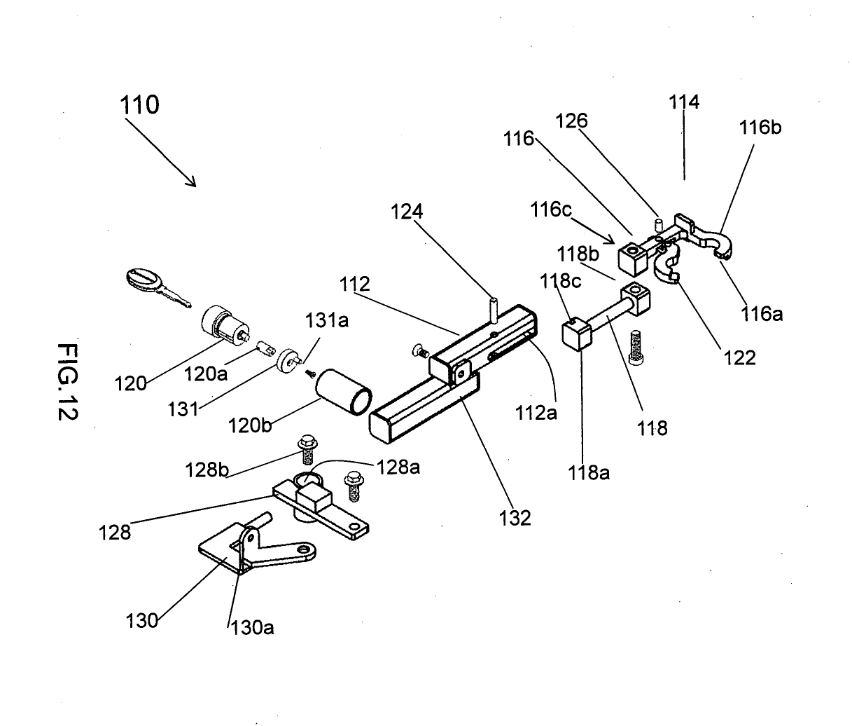

FIG. 12 illustrates a gear lever locking device 110 according to a second preferred embodiment of the present invention. The gear lever locking device 110 includes a first axle pipe 112 having a gear lever transverse mechanism member 114 installed inside the axle pipe 112. An end of the gear lever transverse mechanism member 114 projects from an opening 112a along a side of the axle pipe 112.

The gear lever transverse mechanism 114 includes a first sliding axle 116 having a front end 116a. The front end 116a extends transversely to a longitudinal axis of the sliding axle 116 and projects through the side opening 112a on the wall of the axle pipe 112. The front end 116a is bent to form a curved front transverse rod 116b for retaining or blocking movement of the gear lever (not shown). A rear end 116c of the sliding axle 116 is connected to a side of a second sliding axle 118 (FIG. 12)

The second sliding axle 118 is configured, as shown in FIG. 12, and includes a first end 118a and a second end 118b. The first end 118a of the second sliding axle 118 is coupled to a turning mechanism 120. As such, the second sliding axle 118 is movable by the turning mechanism 120, as further discussed below, which in turns slides the sliding axle 116.

The gear lever transverse mechanism 114 also includes a rear transverse rod 122 positioned rearwardly of the front transverse rod 116b. The rear transverse rod 122 is bent to form a curved rear transverse rod 122 for retaining or blocking the movement of the gear lever and is preferably symmetric to the front transverse rod 116b. The rear transverse rod 122 is pivotably connected to axle pipe 112 by a stud 124 and projects though the opening 112a of the axle pipe 112. The rear transverse rod 122 is also fixed to the sliding axle 116 by a stud 126. Thus, as the sliding axle 116 slides forwardly and rearwardly, the rear transverse rod 122 pivots between an open configuration and a closed configuration.

The gear lever locking device 110 also includes a stand 128 and screw guard member 130. The stand 128 is connected to a bottom part of the axle pipe 112 and/or a second axle pipe 132 for fixing the gear lever locking device 110 to a vehicle's console about an existing screw position (not shown). The second axle pipe 132 is configured as shown in FIG. 12. The stand 128 is configured, as shown in FIG. 12, and includes at least one end having a sleeve 128a extending upwardly or vertically to prevent removal of a screw 128b that secures the stand 128 to the vehicle.

The screw guard member 130 is configured, as shown in FIG. 12, and is fixed to the wall of the axle pipe 112 or to the second axle pipe 132. The screw guard member 130 is bent to form at least one end 130a that receives the sleeve 128a of the stand 128 at a position higher than the position of a head of the screw 128b fixing the stand 128 to the vehicle so as to prevent removal of the screw 128b.

The turning mechanism 120 includes a turning lock unit (not shown), an axle 120a, a casing 120b and a cam 131. The cam 131 is connected to the rotating axle 120a and pivots about a central axis. The turning mechanism 120 is installed about a side wall of the second axle pipe 132, preferably about a rear end of the second axle pipe 132, as shown in FIG. 12. The turning lock unit is installed inside the casing 120b. A rear part of the turning lock unit is connected to the axle 120a, which is also connected to the cam 131.

The cam 131 includes a pivot 131a extending from an offset point of the cam 131. The pivot 131a engages with a notch groove 118c on the rear end of the second sliding axle 118.

In operation, the turning mechanism 120 is turned to move the gear lever transverse mechanism between the open and closed configurations. That is, turning the turning mechanism 120 causes the pivot 131a, which is engaged with the notch groove 118c, to pivot thereby sliding the second sliding axle 118. The second sliding axle 118, being connected to the sliding axle 116, causes the sliding axle 116 to correspondingly slide. As a result, the sliding movement of the sliding axle 116, being connected to the rear transverse rod 122, causes the rear transverse rod 122 to pivot about the stud 124 between the open and closed configurations.

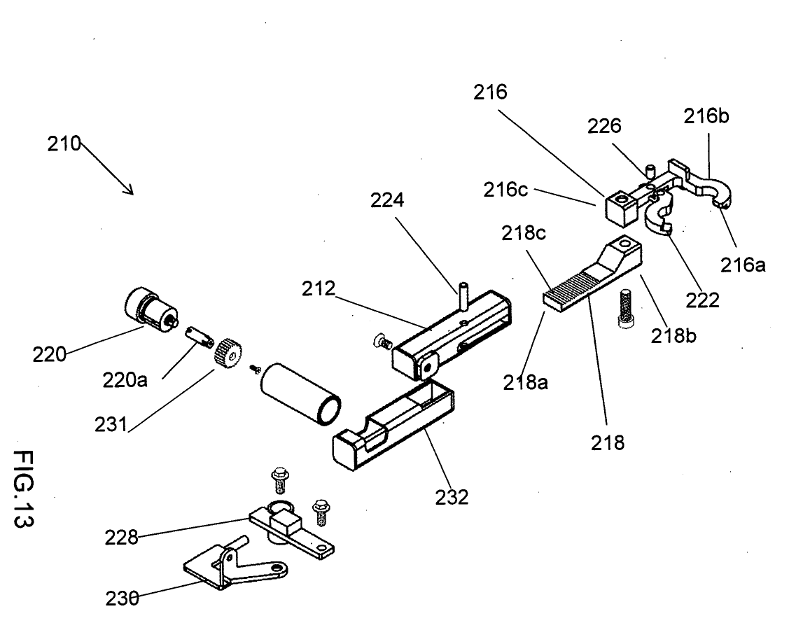

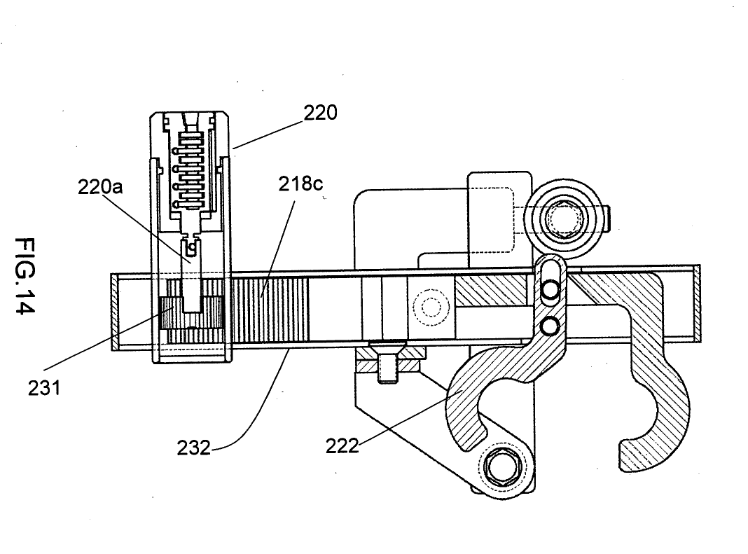

FIGS. 13 and 14 illustrate a gear lever locking device 210 in accordance with a third preferred embodiment of the present invention. The gear lever locking device 210 is similar to the gear lever locking device 110 except for the second sliding axle 218 and the turning mechanism 220.

The second sliding axle 218 is configured as best shown in FIG. 13 and includes rear end 218a and a front end 218b. The front end 218b is connected to a rear end 216c of the first sliding axle 216. The rear end 218a of the second sliding axle 218 includes a gear rack 218c about an upper surface of the sliding axle 218. The gear rack 218c is assembled and installed inside the second axle pipe 232. The gear rack 216c is also coupled to the turning mechanism 220 for driving the movement of the second sliding axle 218 along the length of the axle pipe 212.

The turning mechanism 220 of the third preferred embodiment is similar to the turning mechanism 120 of the above second preferred embodiment, except that the turning mechanism 220 includes a driving gear 231 rather than the cam 131. The driving gear 231 is connected to the axle 220a and rotatable as the turning mechanism 220 is rotated. When assembled with the second axle pipe 232, as shown in FIG. 14, the teeth of the driving gear 231 engage the gear rack 218c of the second sliding axle 218, thereby providing the driving force or driving mechanism for moving the sliding axle 216 and transverse rod 222 between the open and closed configuration.

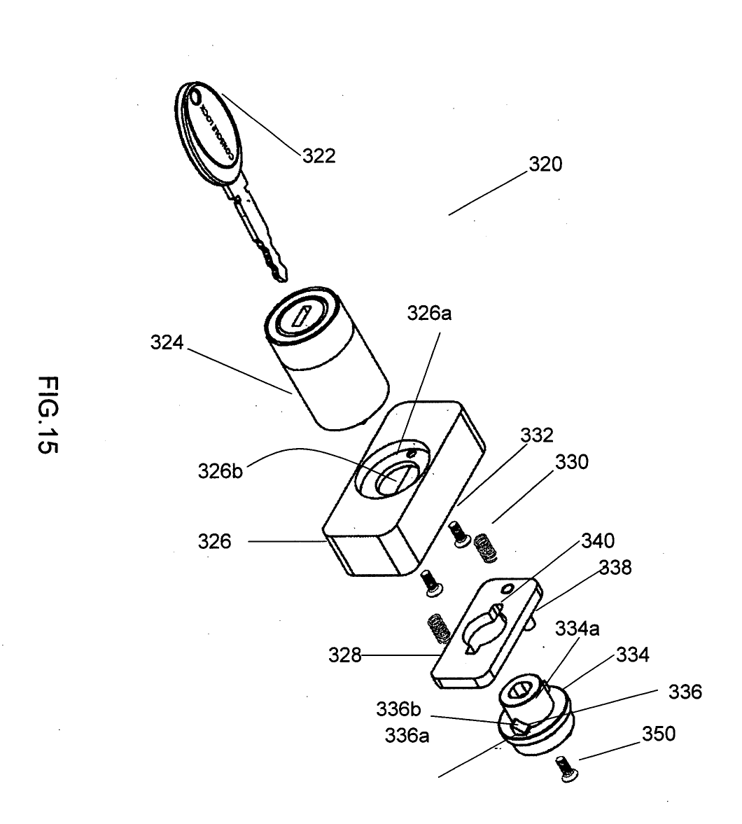

FIGS. 15-17 illustrate a fourth preferred embodiment of a gear lever locking device of the present invention having a turning mechanism 320. The turning mechanism 320 includes a key 322, a key lock cylinder 324, a case 326, a plate 328, springs 330, a fixing device 332 and a cam 334, as shown in FIG. 15. The turning mechanism 320 is preferably incorporated along a side wall of a sliding axle pipe 344, as similarly described in the above first preferred embodiment of the gear lever locking device 10. The turning mechanism 320 is configured to be turnable with the key 322.

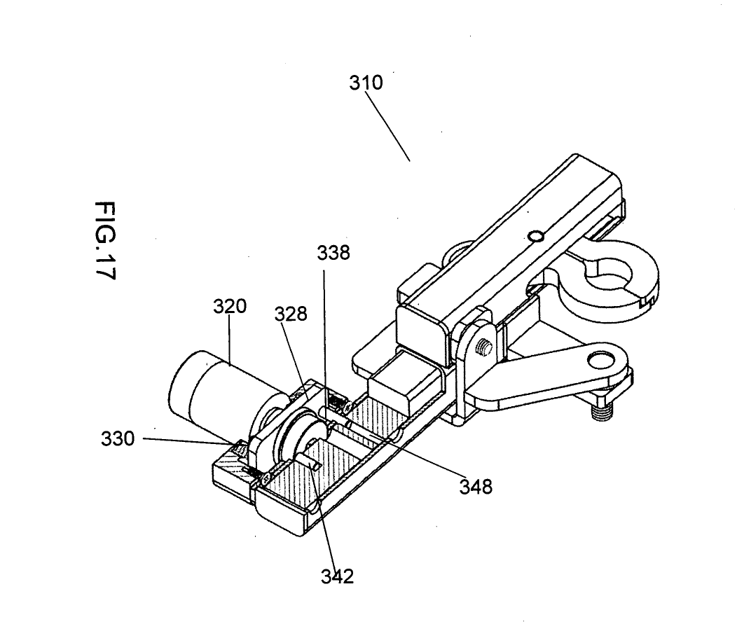

The key lock cylinder 324 is installed in and connected to a case 326 that houses the springs 330, plate 328 and cam 334. The case 326 has an opening 326a for receiving the key 322 and a plate 326b for closing the opening 326a. This assembly is connected to the side wall of the sliding axle pipe 344 by fixing devices 332, such as screws (see also FIG. 17).

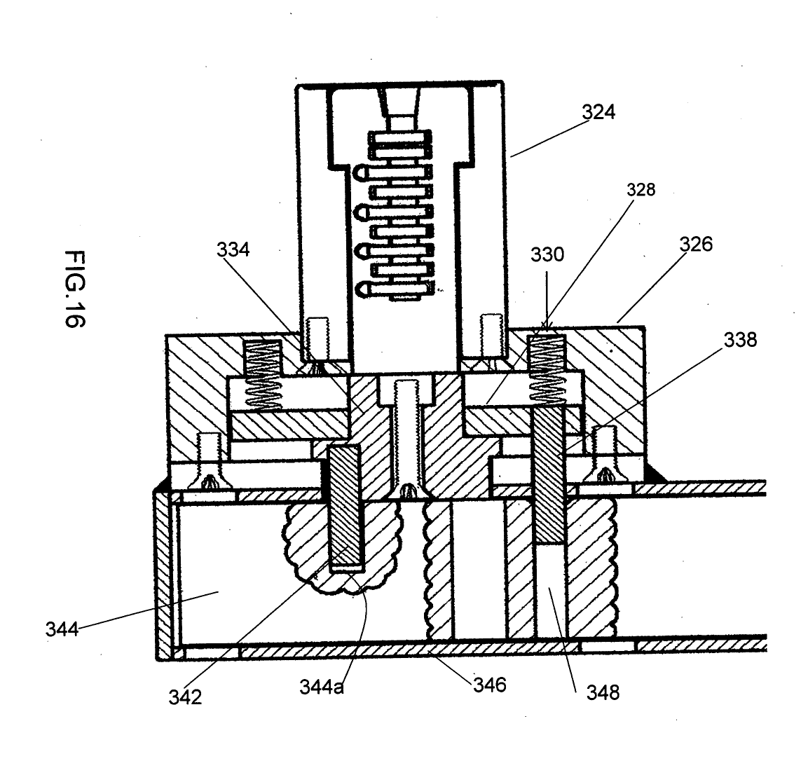

The cam 334 is configured as best shown in FIG. 15 and includes convex studs 336 about an upper end of the cam 334, a stud 342 (FIG. 16) that extends downwardly about a lower end of the cam 334, and an axle 334a. The cam 334 is connected to the case 326 by a connecting device 350, such as a screw. When assembled to the sliding axle pipe 344 and sliding axle pipe 346, the stud 342 extends into the sliding axle pipe 344 so as to be received within an aperture 344a of the sliding axle pipe 344. This allows the cam 334 to engage the sliding axle pipe 344 and drive the sliding axle pipe 344 to move in relation with the turning direction of the key lock cylinder 324. The convex studs 336 have a side wall 336a that moves in relation with the turning direction of the turning mechanism 320 and an oblique wall 336b (or a tilt plane) about its proximal end making an angle with a horizontal plane of the cam 334 orthogonal to a longitudinal axis of the axle 334a.

The plate 328 includes a slot 340 configured to receive the axle 334a and convex studs 336 of the cam 334. The plate 328 also includes a stud 338 extending downwardly from an underside of the plate 328. The plate 328 is assembled onto the axle 334a of the cam 334 with springs 340 interposed between an upper surface of the plate 328 and the case 326, as best shown in FIG. 16.

The plate 328 can be biased off of the cam 334 by turning the cam 334 via the key lock cylinder 324 and key 322, such that the convex studs 336 and the plate 328 upwardly relative to the cam 334. As a result, the convex studs 336 are rotated out of position relative to the slot 340 of the plate 328. This action of camming the plate 328 off of the cam 334 thereby raises the plate's stud 338 out of engagement with the sliding axle 344 so as to unlock the sliding axle 344. To thereafter lock the sliding axle 344, the turning mechanism 320 is rotated in the opposite direction to align the convex studs 336 with the slot 340, thereby producing a coupling between the support plate 328 and the cam 334. Then, due to the force of the springs 330, the stud 338 is pushed back into engagement with the hole 342a of the sliding axle 342.

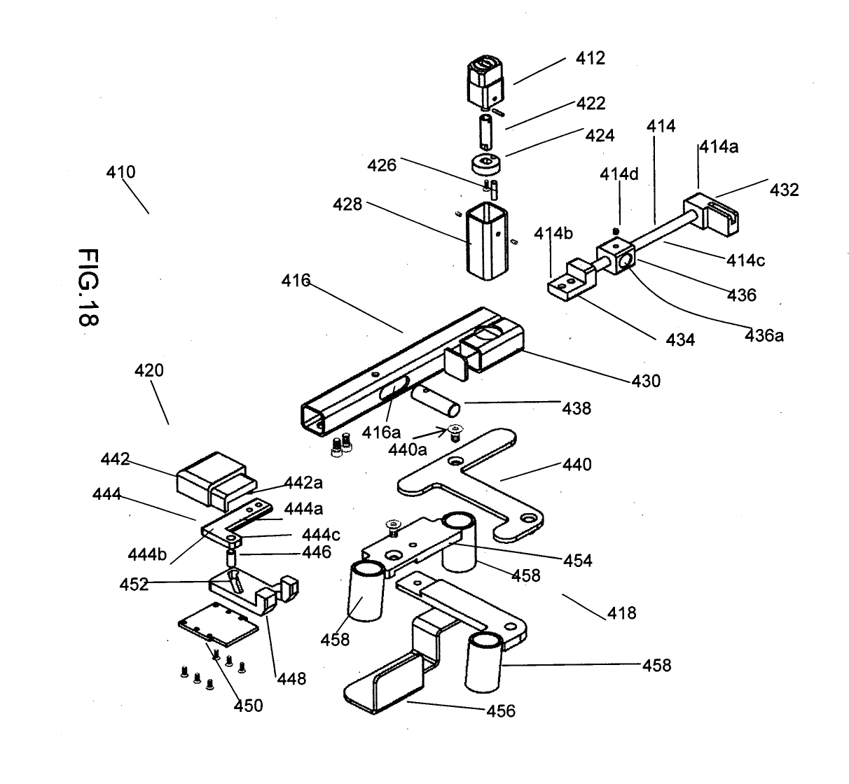

FIGS. 18-20 illustrate a gear lever locking device 410 in accordance with a fifth preferred embodiment of the present invention. The gear lever locking device 410 includes a turning mechanism 412, a sliding axle unit 414, a sliding axle chamber 416, a fixture 418 and a gear lever transverse mechanism 420.

The turning mechanism 412 provides the means for driving or moving the gear lever locking device 410 between a closed configuration and an open configuration i.e., a driving mechanism unit. That is, the turning mechanism 412 is turnable with a key (not shown) for driving the sliding axle unit 414, similar to the second preferred embodiment. The turning mechanism 412 includes a turning axle 422, a cam 424, an axle stud 426, and a turning mechanism chamber 428 and is configured as generally described for the turning mechanism 120 of the second preferred embodiment. The turning mechanism chamber 428 is connected to a mechanism chamber 430 which in turn is connected to a rear end of the sliding axle chamber 416. The turning mechanism 412 is configured to have the stud 426 engage with a stud groove 432 about the rear end of the sliding axle unit 414.

The sliding axle unit 414 includes a first end 414a and a second end 414b. The stud groove 432 is configured about the first end 414a and a member end 434 is configured about the second end 414b. The member end 434 connects to the gear lever transverse mechanism 420. The sliding axle unit 414 also includes an elongated cylindrical rod 414c that connects the first and second ends 414a, 414b and a member 436 rigidly mounted on the cylindrical rod 414c and secured in place by a screw 414d. The member 436 is mounted onto the cylindrical rod 414c so as to be correspondingly positioned with the opening 416a of the sliding axle chamber 416 when assembled thereto. The member 436 includes a recess 436a for receiving an axle 438 that extends out from a side wall of the sliding axle chamber 416, as further discussed below.

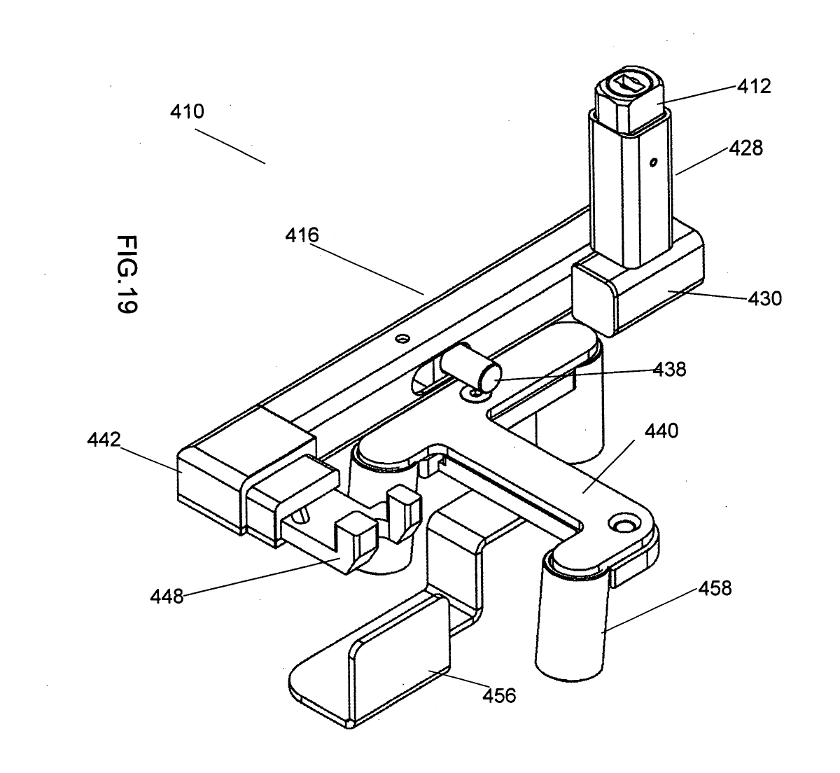

The sliding axle chamber 416 is configured, as best shown in FIG. 18. The sliding axle chamber 416 includes an elongated opening 416a about a side wall of the sliding axle chamber 416. The opening 416a is located about a mid-portion of the sliding axle chamber 416 such that the opening 416a is positioned above a screw 440a the secures the gear lever locking device 410 to the vehicle. In particular, when the sliding axle unit 414 is assembled within the sliding axle chamber 416, the axle 438 extends through the opening 416a so as to extend over the position of the screw 440a when the gear lever locking device 410 is in the locked configuration, as shown in FIG. 19.

The gear lever transverse mechanism 420 is connected to a front end of the sliding axle chamber 416 and configured as best shown in FIG. 18. The gear lever transverse mechanism 420 includes a mechanism unit chamber 442, a plate member 444, a transverse stud 446, a gear lever transverse member 448, and a cover 450. The mechanism unit chamber 442 is configured as shown in FIG. 18 and includes a side opening 442a facing a direction transverse to the longitudinal direction of the sliding axle chamber 416. The plate member 444 is generally “L” shaped having a major end 444a and a minor end 444b. The major end 444a is connected to the second end 414b of the sliding axle unit 414, such as by screws (not shown). Thus, as the sliding axle unit 414 moves within the sliding axle chamber 416, it correspondingly moves the plate member 444. The minor end 444b includes a thru-hole 444c for receiving and connecting to the transverse stud 446, such that the transverse stud 446 extends downwardly.

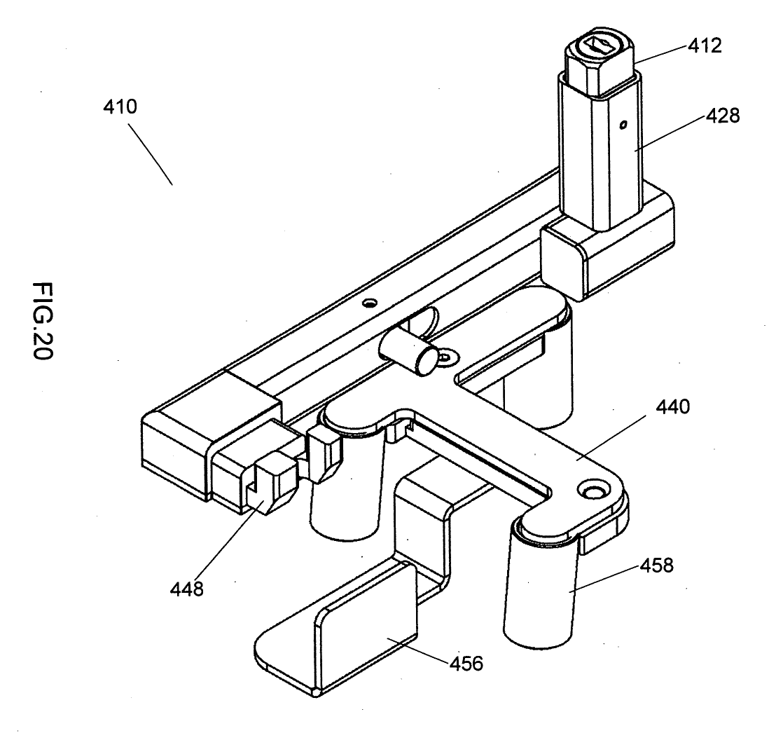

The gear lever transverse member 448 includes a sliding groove 452 configured about a upper surface of the gear lever transverse member 448 facing the plate member 444. The gear lever transverse member 448 is configured to extend through the opening 442a of the mechanism unit chamber 442 transversely with respect to the sliding axle chamber 416. The sliding groove 452 receives the transverse stud 446, such that the gear lever transverse member 448 can slide relative to the transverse stud 446. That is, as the plate member 444 is moved via the turning mechanism 412, the plate member 444 causes the gear lever transverse member 448 to extend further out to a locked configuration, as shown in FIG. 19, or to an unlocked configuration, as shown in FIG. 20, in which the gear lever transverse member 448 is in a retracted position.

The cover 450 is a plate cover that secures the plate member 444, transverse stud 446 and gear lever transverse member 448 into the mechanism unit chamber 442. The cover 450 is attached to the mechanism unit chamber 442 by screws.

The fixture 418 includes a first stand unit 454, a second stand unit 456 and a screw guard 440. The first and second stand units 454, 456 are configured as shown in FIG. 18. In general, the first and second stand units 454, 456 are configured to be sized and shaped to allow the sliding axle chamber 416 to mount thereon and for the first and second stand units 454, 456 themselves to be mounted onto a vehicle about existing screw positions near the vehicle's console that houses the gear lever (not shown). Preferably, the first and second stand units 454, 456 also includes sleeves 458 for covering the screw locations. The screw guard 440 provides a plate covering that covers the sleeve openings to prevent an individual from access to the screw locations and thereby prevent an individual from removing or disabling the gear lever locking device 410. The screw 440a secures the screw guard 440 in place. Thus, as the axle 438 is positioned above the screw 440a when the gear lever locking device 410 is in the locked position, removal or disabling of the gear lever locking device 410 is prevented.

In operation, the turning mechanism 412 operates similar to the turning mechanism 120 of the second preferred embodiment, to move the gear lever transverse mechanism 448 between the locked and unlocked configurations. That is, turning the turning mechanism 412 causes the axle stud 426, which is engaged with the stud groove 432, to pivot thereby sliding the sliding axle unit 414 within the sliding axle chamber 416. The member 434 of the sliding axle unit 414 is connected to the plate member 444 such that the plate member 444 slides correspondingly with the sliding axle unit 414. As a result, the sliding movement of the plate member 444 causes the transverse stud 446 of the plate member 444 to travel within the sliding groove 452, which in turn causes the gear lever transverse member 448 to either retract (unlocked configuration) or extend (locked configuration) from the mechanism unit chamber.

It will be appreciated by those skilled in the art that changes could be made to the embodiments described above without departing from the broad inventive concept thereof. For example, additional components and steps can be added to the various gear lever locking devices. It is to be understood, therefore, that this invention is not limited to the particular embodiment disclosed, but it is intended to cover modifications within the spirit and scope of the present invention as defined by the appended claims.

1-30. (canceled)

31. A gear lever locking device (10) comprising:
a first main axle pipe (12) having:
an interior (12a), a bottom (12b), and a side wall (12c),
a bent first fixing leg member (30) extending from the bottom for installation in a vehicle at an existing position of a screw of the vehicle's console that houses a gear lever,
a through-slot (36) along a rear end of the side wall,
an opening (28) along the side wall, and
a through hole (26) along the side wall;
a first sliding axle pipe (14) having:
a shape corresponding to the interior (12a) of the first main axle pipe (12) and installed inside of the first main axle pipe (12), and
a through hole (34) along a side wall of the first sliding axle pipe (14)
a spring (16) inside a front end of the first sliding axle pipe (14);
a sliding-pulling axle (18) fixed to the first sliding axle pipe (14), wherein the through-slot (36) is configured to receive the sliding pulling axle (18);
an extending axle (20) extending through the opening (28) and fixed to the first sliding axle pipe (14) in a position blocking an area above the screw when the first sliding axle pipe (14) slides into a locked position; and
a second main axle pipe (24) connected to a front end of the first main axle pipe (12) by a first connecting member (38) and to a front end of the first sliding axle pipe (14) by a second connecting member (40), the second main axle (24) comprising:
a sliding axle (42) having an end (42a) projecting through a side opening (24a) on a wall of the second main axle (24) and bent to form a front transfer member (42c),
a transverse axle (44) positioned rearwardly from the sliding axle (24) and bent to form a rear transverse rod (44a), the transverse axle having an inner end (44b) pivotably fixed to the second main axle pipe (24) by a stud (46) and wherein the transverse axle is configured to turn with a stud (50) fixed to the sliding axle (42) between a closed configuration wherein the gear lever is locked in position and an open configuration wherein the gear lever is freely movable between the transverse axle (44) and the sliding axle (42),
at least one bent second fixing leg member (52) about a bottom of the second main axle pipe (24) for securing to another existing position of a screw of the vehicle's console; and
a turning mechanism (56) installed on the side wall of the first main axle pipe (12), the turning mechanism (56) comprising:
a turning unit (56a) having an offset part (56b) inserted inside a rear groove (62a) of a locking stud (62), wherein the locking stud (62) extends into the through hole (26) of the first main axle pipe (12) and the through hole (34) of the first sliding axle pipe (14) to a locking position for preventing relative movement;
a spring (60) positioned between the locking stud (62) and a casing (56c) housing the turning unit (56a) for biasing a rear end of the locking stud (62) to extend towards the through hole (34) of the first sliding axle pipe (14);
wherein upon turning the turning mechanism (56), the bottom end of the turning unit (56a) is pushed against the locking stud (62) to move the locking stud (62) from a locked position that corresponding to the closed configuration to an unlocked position that corresponds to the open configuration, thereby allowing the first sliding axle pipe (14) to slide under the force of the spring (16).

32. The gear lever locking device according to claim 1, wherein the extending axle (20) is fixed to both side walls of the first sliding axle pipe (14) and extends through respective openings of the side wall of the first main axle pipe (12) and wherein the first sliding axle pipe (14) is movable between a first position and a second position located above the screw of the first fixing leg member (30).

33. The gear lever locking device according to claim 2, wherein the first fixing leg member (30) comprises a screw guard (32) covering a first fixing leg screw fixed to an upper end of the first fixing leg member (30).

34. The gear lever locking device according to claim 1, wherein an end of the spring (16) pushes against an end cap (14c) of the first sliding axle pipe (14) and an opposite end of the spring (16) pushes against a transverse stud (54) fixed to a wall of the first main axle pipe (12) and wherein the opening along the side wall of the first main axle pipe (12) has a length equal to a predetermined sliding length of the first sliding axle pipe (14) relative to the first main axle pipe (12).

35. The gear lever locking device according to claims 1-4, wherein the inner end of the transverse axle (44) further comprises an elongated through hole (48) to receive the stud (50) to move the transverse rod (44a) between an open and closed configuration with respect to the sliding axle (24).

36. The gear lever locking device according to claims 1-5, further comprising a wiring (21) connected to an anti-theft system, the wiring (21) having:
a first socket (20a);
a second socket (20b) for connecting to the electric wires; and
a ground connected to the switch.

37. A gear lever locking device (110) comprising:
a first axle pipe (112) having a side opening (112a) on a wall of the first axle pipe;
a gear lever transverse assembly (114) installed inside the first axle pipe (112) and extending from the side opening (112a), the gear lever transverse assembly (114) comprising:
a first sliding axle (116) having a bent front end (116a) projecting through the side opening (112a) to form a front transverse rod for blocking movement of a gear lever,
a bent rear transverse rod (122) projecting through the side opening (112a) to form a rear transverse rod for blocking movement of the gear lever and pivotably connected to the first axle pipe (112) by a stud (126), the rear transverse rod having an elongated opening about an end, and
a stud (126) fixed on the first sliding axle (116) extending through the elongated opening,
wherein the rear transverse rod is pivoted about the stud (126) when the first sliding axle (116) is moved to move the rear transverse rod between an open position and a closed position;
a second axle pipe (132) connected to the first axle pipe (112);
a second sliding axle (118) installed inside the second axle pipe (132) and operatively assembled to a rear end of the first sliding axle (116); and
a turning mechanism (120) installed on a wall of the second axle pipe (132),
wherein an end of the second sliding axle (118) is operatively assembled with the turning mechanism (120) such that turning the turning mechanism (120) causes the second sliding axle (118) to slide between an open configuration wherein the gear lever is freely movable between the bent front end (116a) and the bent rear transverse rod (122), and a closed configuration wherein the gear lever is locked in position.

38. The gear lever locking device according to claim 7, wherein the turning mechanism (120) comprises:
a case (120b); and
a turning lock installed inside the case (120b) and connected to a cam (131),
wherein the turning lock is assembled on the second axle pipe (132), and
wherein the cam (131) is configured to pivot from an offset position to engage a notch groove (118c) on a rear end of the second sliding axle (118).

39. The gear lever locking device according to claim 7, wherein the turning mechanism (220) comprises a turning lock connected to a driving gear (231), wherein the second sliding axle (218) comprises a gear rack (218c), and wherein the driving gear (231) is engaged with the gear rack (218c) of the second sliding axle (218) to move the second sliding axle (218) such that the rear transverse rod (222) is movable between an open position and a closed position.

40. The gear lever locking device according to claim 7, wherein the turning mechanism comprises:
a case (326);
a support plate (328) installed inside the case (326) in a movable manner, the support plate (328) having:
a front part that includes at least one second locking stud (338) extending through a hole on the wall of the first axle pipe to a hole on the second sliding axle at a position to block the movement of the first sliding axle in a locked position,
an opening for receiving a turning lock unit of the turning mechanism, and
at least one spring (330) about a rear part of the support plate (328) biasing the support plate to slide the second locking stud (338) into the hole (348) when the hole on the wall of the first axle pipe is in line with the hole on the second sliding axle; and
a cam (334) having projecting parts configured as convex studs (336b) having a tilt plane, and positioned to correspond to a slot (340) on the support plate (328) for receiving the convex stud (336b) to make the support plate (328) move and the stud slide off from the hole into an unlocked position or to slide into the hole of the second sliding axle into the locked position.

41. The gear lever locking device according to claim 7, wherein the turning mechanism comprises:
a case (326);
a key lock cylinder (324) partially housed within the case (326) and turnable with a key;
a fixing device (332) for connecting the turning mechanism to the second axle pipe;
a cam (334) connected to the key lock cylinder (324) by a connecting device, the cam (334) including a convex stud (336b) and a stud (342),
wherein the cam (334) engages with the second sliding axle to drive the second sliding axle and move in the turning direction of the key lock cylinder (324); and
a plate (328) operatively connected to the cam (324), the plate (328) having:
a stud (338) extending therefrom, and
a slot (340) for receiving the convex stud,
wherein the second sliding axle comprises a hole for receiving the stud (338),
wherein the plate (328) is configured to be moved by camming engagement with the cam (334) to withdrawal the convex stud (33b) from the slot (340) and the stud (338) from the hole to unlock the sliding axle, and
wherein the plate (328) is configured to be moved by the cam (334) to insert the convex stud into the slot to allow a spring (330) to push the stud into the hole and into a lock position.

42. The gear lever locking device according to claim 11, wherein the convex stud (336b) includes an oblique wall to cam the plate (328) to the unlock position.

43. The gear lever locking device according to claims 11-12, wherein the key lock cylinder (324) further comprises a plate (338) closing the opening on the case (326).

44. The gear lever locking device according to claim 7, further comprising the second sliding axle having a gear rack (218c) installed inside of the second axle pipe,
wherein the gear rack (218c) is connected to a driving gear of the turning mechanism, and
wherein a rear end of the first sliding axle is coupled to a front end of the second sliding axle.

45. The gear lever locking device according to claim 7, wherein the turning mechanism comprises:
a case (326); and
a turning lock installed inside the case (326) and assembled on either side of the wall of the second axle pipe, the turning lock including a driving gear that rotates about an axis,
wherein the driving gear (231) is coupled to a gear rack (218c) on the second sliding axle to move the first sliding axle which thereby moves the front transverse rod and the rear transverse rod towards one another.

46. The gear lever locking device according to claim 7, wherein the second sliding axle (118) has a hole to receive the stud end in a locked position.

47. The gear lever locking device according to claims 7-16, wherein the front transverse rod (116a) and the rear transverse rod (122) are bent to retain the gear lever.

48. The gear lever locking device according to claims 7-17, further comprising a stand (454) connected to a bottom part of the first axle pipe or the second axle pipe, the stand includes an end having a sleeve (458) extending upwardly for preventing the removal of a screw fixing the stand to a vehicle.

49. The gear lever locking device according to claims 7-18, further comprising a screw guard member (440) fixed to the wall of the first axle pipe or the second axle pipe,
wherein the screw guard member (440) is bent to form at least an end having an engagement to a side opening of the sleeve (458) of the stand (454) at a position higher than the position of a head of a screw fixing the stand to a vehicle.

50. A gear lever locking device (410), comprising:
a sliding axle chamber (416) having a sliding axle unit (414) slideable therein;
a driving mechanism unit engaged with a first end of the sliding axle unit (414), the driving mechanism having a turning mechanism (412) turnable with a key for driving the sliding axle unit (414); and
a gear lever transverse mechanism (420) provided in a mechanism unit chamber (442) connected to and extending from a second end of the sliding axle unit (414), the gearlever transverse mechanism (420) includes:
a plate member (444) extending from a member end of the sliding axle unit (414), the plate member having a transverse stud (446) in a sliding groove (452) of a gear lever transverse member (448) that moves in relation to a movement of the driving mechanism unit, and
a fixture (418) connected to the sliding axle chamber (416) for fixing the gear lever locking device (410) to an existing screw position in a vehicle's console that houses a gear lever,
wherein the gear lever transverse member (448) is configured as a parallel projecting axle positioned transverse to a movement direction of a gear lever and extending from the gear lever transverse mechanism (420) when in a locked position, and
wherein the gear lever transverse member (448) is retracted from the extended position when in an unlocked position, and wherein the gear lever transverse member (448) is caused to either retract to the unlocked position or extend to the locked position by the turning mechanism (412).

51. The gear lever locking device according to claim 20, wherein the sliding axle unit (414) comprises:
a member (434); and
an axle (414) extending from the member (434) and through a side opening of the sliding axle chamber (416) at a position corresponding to a screw fixing a screw guard in position.

52. The gear lever locking device according to claim 21, wherein the sliding axle chamber (416) further comprises a mechanism chamber positioned at a first end of the sliding axle chamber (416) and a mechanism unit chamber (430) positioned at a second end of the sliding axle chamber, wherein the mechanism unit chamber (430) includes:
an opening to receive the gear lever transverse member (448); and
a cover (450) covering the mechanism unit chamber (430).

53. The gear lever locking device according to claim 20, wherein the driving mechanism unit is located inside the turning mechanism chamber (428), the driving mechanism unit comprising:
a cam (424) having an axle stud (426) for engaging with a stud groove on the first end of the sliding axle unit; and
a turning mechanism (410) having a turning axle (422) extending to the cam (424).

54. The gear lever locking device according to claim 20, wherein the fixture comprises legs, each leg having a cylindrical screw chamber (458) at a position corresponding to the existing screw position in the vehicle for fixing the leg to the vehicle.

55. The gear lever locking device according to claim 20, wherein an upper end of the fixture includes a screw guard (440) configured to have a shape corresponding to a shape of the upper end of a first stand unit and fixed to the first stand unit with a screw guard fixing screw.

56. The gear lever locking device according to claim 25, wherein at least one screw guard fixing screw (440a) is positioned below the position of the axle (438) extending from the member when the gear lever locking device is in the locked position.
